(19) United States
(12) Patent Application Publication
(10) Pub. No.: US 2024/0155218 A1
(43) Pub. Date: May 9, 2024

(54) CAMERA MODULE AND ELECTRONIC DEVICE COMPRISING SAME

(71) Applicant: Samsung Electronics Co., Ltd., Suwon-si (KR)

(72) Inventor: Sewon KIM, Suwon-si (KR)

(21) Appl. No.: 18/417,440

(22) Filed: Jan. 19, 2024

Related U.S. Application Data
(63) Continuation of application No. PCT/KR2022/010533, filed on Jul. 19, 2022.

(30) Foreign Application Priority Data
Jul. 21, 2021 (KR) 10-2021-0095825

(51) Int. Cl. H04N 23/57; G03B 30/00; H04N 23/68

(52) U.S. Cl. CPC H04N 23/57; G03B 30/00; H04N 23/687

(57) ABSTRACT

A camera module is provided. The camera module includes a camera housing including a base including a board on which an image sensor is disposed and a cover coupled to the base, a lens carrier at least partially disposed inside the camera housing and configured to move in a direction of an optical axis, a holder disposed inside the camera housing to be coupled to the lens carrier and configured to move in a direction perpendicular to the optical axis together with the lens carrier, a first coil disposed on the base, a second coil disposed on the lens carrier, a magnet disposed in the holder and including a lower surface facing the first coil and an inner surface facing the second coil, and a yoke member attached to an outer surface of the magnet, and each of the inner surface and the lower surface may include an N pole and an S pole.

### CROSS-REFERENCE TO RELATED APPLICATION(S)

This application is a continuation application, claiming priority under § 365(c), of an International application No. PCT/KR2022/010533, filed on Jul. 19, 2022, which is based on and claims the benefit of a Korean patent application number 10-2021-0095825, filed on Jul. 21, 2021, in the Korean Intellectual Property Office, the disclosure of which is incorporated by reference herein in its entirety.

### BACKGROUND

### 1. Field

The disclosure relates to a camera module and an electronic device including the same.

### 2. Description of Related Art

A camera module may perform an image stabilization function for image correction in response to a disturbance. The image stabilization function may be implemented in a manner where a position of light received by an image sensor is changed by moving a lens.

The camera module may perform an autofocus function in response to a focus position of a subject. The autofocus function may be implemented in a manner in which the lens is moved to change a distance between the image sensor and the lens.

The camera module may include at least one coil and magnet for the image stabilization function and the autofocus function. The coil to which a current is applied may generate an electromagnetic force through electromagnetic interaction with the magnet.

The above information is presented as background information only to assist with an understanding of the disclosure. No determination has been made, and no assertion is made, as to whether any of the above might be applicable as prior art with regard to the disclosure.

### SUMMARY

In these days, electronic devices includes a plurality of camera modules. The plurality of camera modules are arranged adjacent to each other, so that magnetic interference occurs due to magnets included in each camera module. Further, a magnetic field generated by the magnet affects the operation of other components (e.g., a receiver) adjacent to the camera module. In addition, in order to reduce magnetic interference, a plurality of camera modules is required to be spaced apart from each other by a specified distance or more. Accordingly, limited space inside the electronic device is not be efficiently utilized, and screen switching time differences between the plurality of camera modules occurs.

Aspects of the disclosure are to address at least the above-mentioned problems and/or disadvantages and to provide at least the advantages described below. Accordingly, an aspect of the disclosure is to provide a camera module configured to reduce magnetic field interference caused by a magnet included in a camera module.

Additional aspects will be set forth in part in the description which follows and, in part, will be apparent from the description, or may be learned by practice of the presented embodiments.

In accordance with an aspect of the disclosure a camera module is provided. The camera module includes a camera housing including a base including a board on which an image sensor is disposed and a cover coupled to the base, a lens carrier at least partially disposed inside the camera housing and configured to move in a direction of an optical axis, a holder disposed inside the camera housing to be coupled to the lens carrier and configured to move in a direction perpendicular to the optical axis together with the lens carrier, a first coil disposed on the base, a second coil disposed on the lens carrier, a magnet disposed in the holder and including a lower surface facing the first coil when viewed in a direction parallel to the optical axis and an inner surface facing the second coil when viewed in the direction perpendicular to the optical axis, and a yoke member attached to an outer surface of the magnet, in which each of the inner surface and the lower surface includes an N pole and an S pole.

In accordance with another aspect of the disclosure, a camera module is provided. The camera module includes a camera housing including a base including a board on which an image sensor is disposed and a cover coupled to the base, a lens carrier at least partially disposed inside the camera housing and configured to move in a direction of an optical axis, a holder disposed inside the camera housing to be coupled to the lens carrier and configured to move in a first direction perpendicular to the optical axis and/or a second direction perpendicular to each of the optical axis and the first direction together with the lens carrier, a first magnet disposed in the holder and positioned in the first direction from the lens carrier and a third magnet positioned in the second direction, a first coil disposed on the base and including at least one 1-1 coil positioned in the first direction from the image sensor and at least one 1-3 coil positioned in the second direction, a second coil disposed on the lens carrier and facing an inner surface of the first magnet and/or the third magnet, and a yoke member coupled to an outer surface of the first magnet or the third magnet, in which each of the outer surfaces and the inner surfaces of the first magnet and the third magnet includes an N pole and an S pole.

A camera module according to embodiments disclosed herein can be configured so that a magnetic field of a magnet forms a local closed loop, thereby reducing magnetic interference to other adjacent components.

According to embodiments disclosed herein, each of a plurality of camera modules can be disposed adjacent to each other, and the camera module can be disposed adjacent to other components including a magnetic material.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram illustrating a camera module, according to an embodiment of the disclosure;

FIG. 3A is a front perspective view of an electronic device according to an embodiment of the disclosure;

FIG. 3B is a rear perspective view of an electronic device according to an embodiment of the disclosure;

FIG. 3C is an exploded perspective view of an electronic device according to an embodiment of the disclosure;

FIG. 4 is a perspective view of a camera module according to an embodiment of the disclosure;

FIG. 5 is an exploded perspective view of a camera module according to an embodiment of the disclosure;

FIG. 6 is an exploded perspective view of a camera module according to an embodiment of the disclosure;

FIG. 7 is a diagram illustrating a magnet, a first coil, and a second coil of a camera module according to an embodiment of the disclosure;

FIG. 8 is a cross-sectional view of a camera module according to an embodiment of the disclosure; and

FIGS. 9A and 9B are diagrams illustrating an arrangement of a plurality of camera modules according to various embodiments the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The one or more programs may be stored in a single memory or divided among multiple memories.

The functions in the claims can be processed by one processor or a combination of processors. The one processor or a combination of processors is circuitry performing processing and includes circuitry like CPU, microprocessor unit (MPU), access point (AP), CP, system on chip (SoC), or integrated circuit (IC).

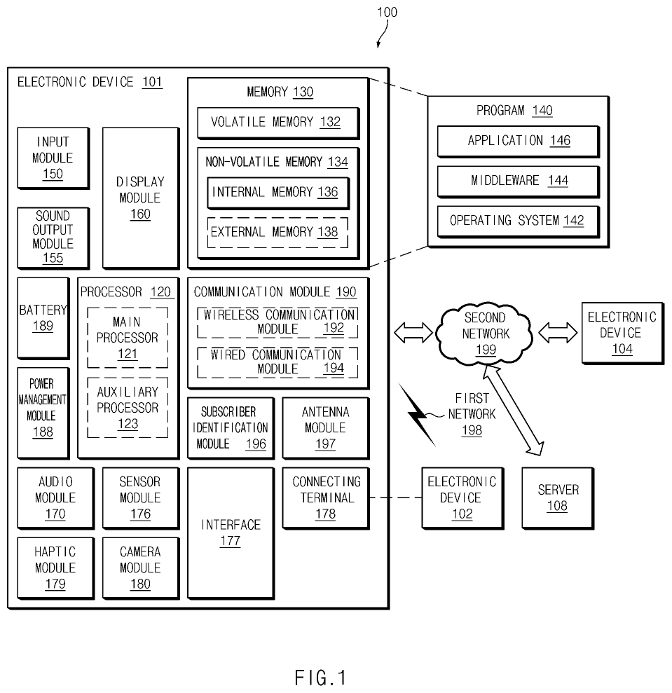

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connecting terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (MPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. The non-volatile memory 134 may include internal memory 136 and external memory 138.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., wiredly) or wirelessly. According to an embodiment of the disclosure, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the external electronic device 102). According to an embodiment of the disclosure, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form a mmWave antenna module. According to an embodiment of the disclosure, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., smart home, smart city, smart car, or healthcare) based on 5G communication technology or IoT-related technology.

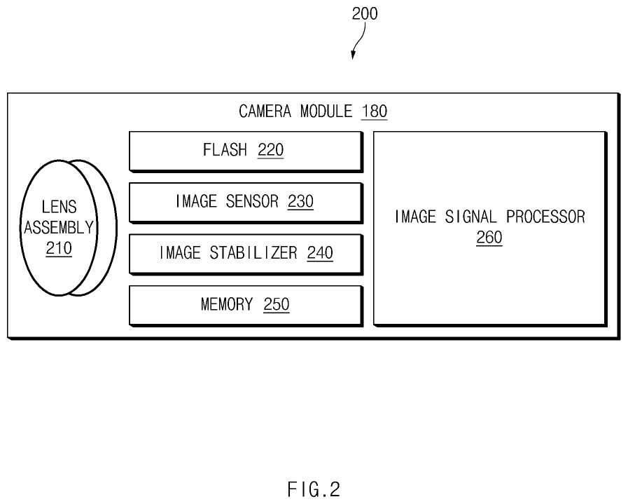

FIG. 2 is a block diagram 200 illustrating a camera module according to an embodiment of the disclosure.

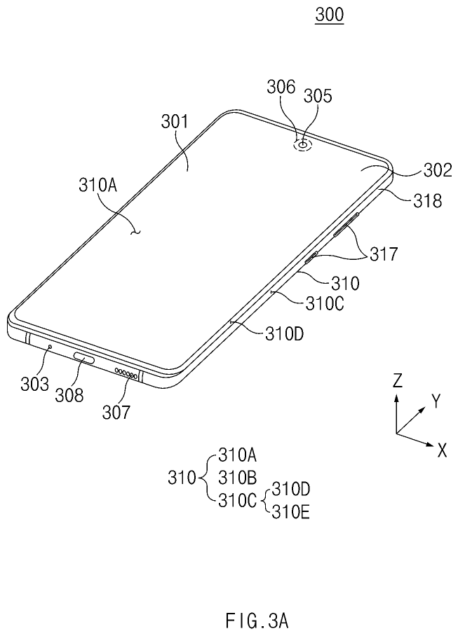

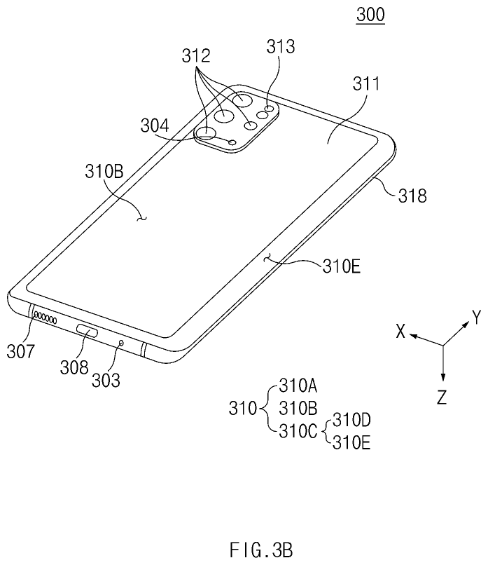

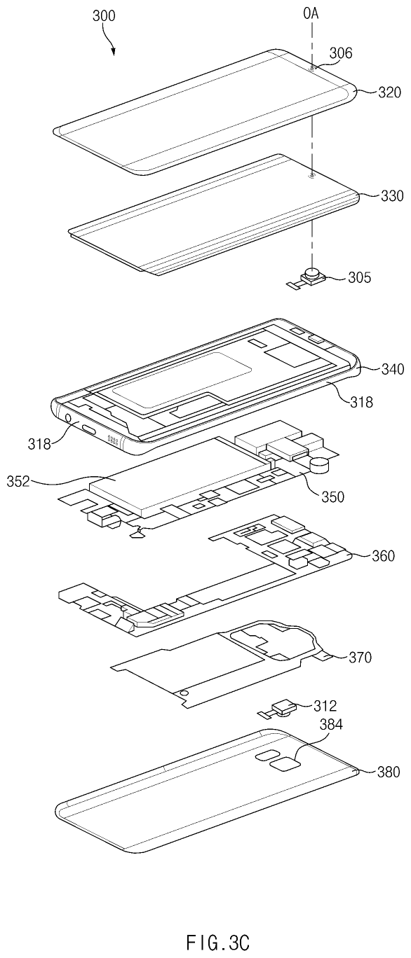

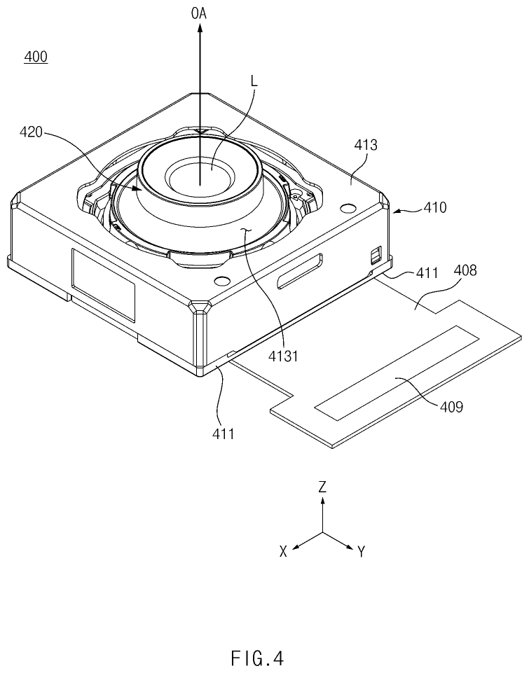

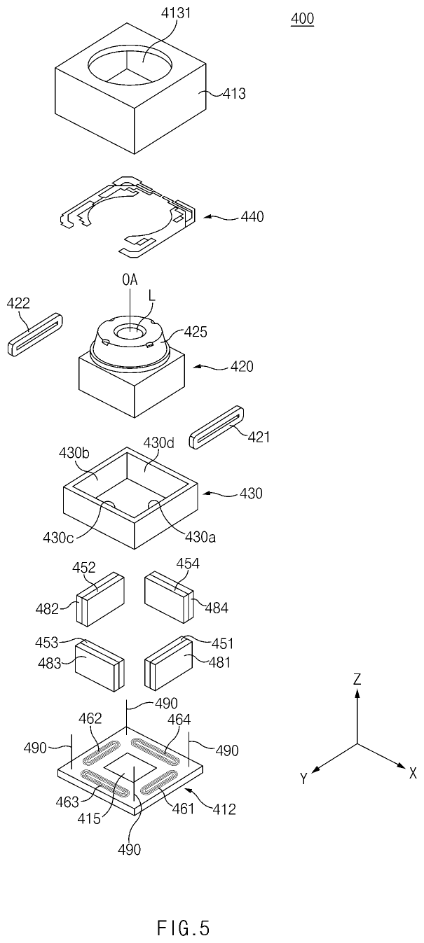

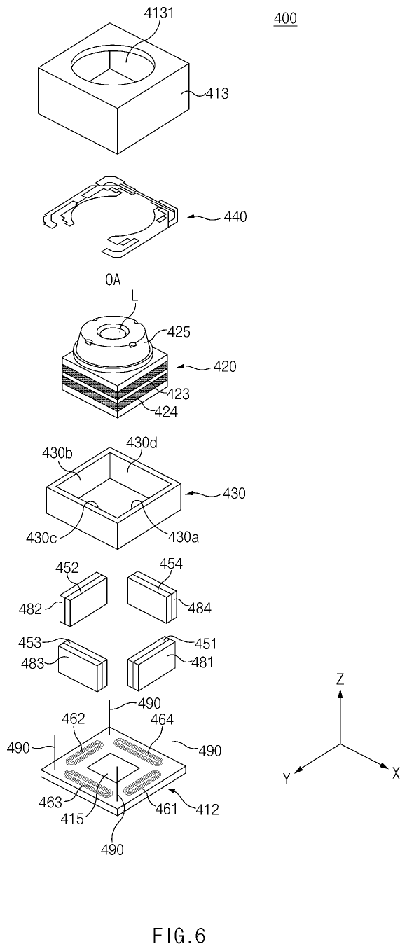

Referring to FIG. 2, the camera module 180 (e.g., a camera module 400 of FIGS. 3A, 3B, and 3C, the camera module 400 of FIG. 4) may include a lens assembly 210 (e.g., a lens assembly 420 of FIG. 6), a flash 220, an image sensor 230 (e.g., an image sensor 415 of FIG. 5), an image stabilizer 240, memory 250 (e.g., buffer memory), or an image signal processor 260. In one embodiment of the disclosure, at least one of the components (e.g., the lens assembly 210, the flash 220, the image sensor 230, the image stabilizer 240, and the memory 250) included in the camera module 180 may operate under the control of a control circuit (e.g., the processor 120 of FIG. 1) of an electronic device (e.g., the electronic device 101 of FIG. 1). For example, the control circuit (e.g., the processor 120 of FIG. 1) may be connected to a main processor (e.g., the main processor 121 of FIG. 1) and/or a co-processor (e.g., the co-processor 123 of FIG. 1) or an image signal processor 260).

In one embodiment of the disclosure, the lens assembly 210 may collect light emitted or reflected from an object whose image is to be taken. The lens assembly 210 may include one or more lenses. According to an embodiment of the disclosure, the camera module 180 may include a plurality of lens assemblies 210. In such a case, the camera module 180 may form, for example, a dual camera, a 360-degree camera, or a spherical camera. Some of the plurality of lens assemblies 210 may have the same lens attribute (e.g., view angle, focal length, auto-focusing, f number, or optical zoom), or at least one lens assembly may have one or more lens attributes different from those of another lens assembly. The lens assembly 210 may include, for example, a wide-angle lens or a telephoto lens.

The flash 220 may emit light that is used to reinforce light reflected from an object. According to an embodiment of the disclosure, the flash 220 may include one or more light emitting diodes (LEDs) (e.g., a red-green-blue (RGB) LED, a white LED, an infrared (IR) LED, or an ultraviolet (UV) LED) or a xenon lamp.

In one embodiment of the disclosure, the image sensor 230 may obtain an image corresponding to an object by converting light emitted or reflected from the object and transmitted via the lens assembly 210 into an electrical signal. According to an embodiment of the disclosure, the image sensor 230 may include one selected from image sensors having different attributes, such as a RGB sensor, a black-and-white (BW) sensor, an IR sensor, or a UV sensor, a plurality of image sensors having the same attribute, or a plurality of image sensors having different attributes. Each image sensor included in the image sensor 230 may be implemented using, for example, a charged coupled device (CCD) sensor or a complementary metal oxide semiconductor (CMOS) sensor.

The image stabilizer 240 may move the image sensor 230 or at least one lens included in the lens assembly 210 in a particular direction, or control an operational attribute (e.g., adjust the read-out timing) of the image sensor 230 in response to the movement of the camera module 180 or the electronic device 101 including the camera module 180. This allows compensating for at least part of a negative effect (e.g., image blurring) by the movement on an image being captured. According to an embodiment of the disclosure, the image stabilizer 240 may detect such a movement by the camera module 180 or the electronic device 101 using a gyro sensor (not shown) or an acceleration sensor (not shown) disposed inside or outside the camera module 180. According to an embodiment of the disclosure, the image stabilizer 240 may be implemented, for example, as an optical image stabilizer.

The memory 250 may store, at least temporarily, at least part of an image obtained via the image sensor 230 for a subsequent image processing task. For example, if image capturing is delayed due to shutter lag or multiple images are quickly captured, a raw image obtained (e.g., a Bayer-patterned image, a high-resolution image) may be stored in the memory 250, and its corresponding copy image (e.g., a low-resolution image) may be previewed via the display module 160. Thereafter, if a specified condition is met (e.g., by a user's input or system command), at least part of the raw image stored in the memory 250 may be obtained and processed, for example, by the image signal processor 260. According to an embodiment of the disclosure, the memory 250 may be configured as at least part of the memory 130 or as separate memory that is operated independently from the memory 130.

In one embodiment of the disclosure, the image signal processor 260 may perform one or more image processing with respect to an image obtained via the image sensor 230 or an image stored in the memory 250. The one or more image processing may include, for example, depth map generation, three-dimensional (3D) modeling, panorama generation, feature point extraction, image synthesizing, or image compensation (e.g., noise reduction, resolution adjustment, brightness adjustment, blurring, sharpening, or softening). Additionally or alternatively, the image signal processor 260 may perform control (e.g., exposure time control or read-out timing control) with respect to at least one (e.g., the image sensor 230) of the components included in the camera module 180. An image processed by the image signal processor 260 may be stored back in the memory 250 for further processing, or may be provided to an external component (e.g., the memory 130, the display module 160, the external electronic device 102, the external electronic device 104, or the server 108) outside the camera module 180.

According to an embodiment of the disclosure, the image signal processor 260 may be configured as at least part of the processor 120, or as a separate processor that is operated independently from the processor 120. If the image signal processor 260 is configured as a separate processor from the processor 120, at least one image processed by the image signal processor 260 may be displayed, by the processor 120, via the display module 160 as it is or after being further processed.

According to an embodiment of the disclosure, an electronic device (e.g., the electronic device 101 of FIG. 1) may include a plurality of camera modules 180, each with different properties or functions. For example, the plurality of camera modules 180 may be configured including lenses (e.g., lens assemblies 210) having different angles of view, and based on a user's selection, the electronic device 101 may be controlled to use the angle of view of the camera module 180 related to the selection. For example, at least one of the plurality of camera modules 180 may be a wide-angle camera, and at least another one may be a telephoto camera. Similarly, at least one of the plurality of camera modules 180 may be a front camera, and at least another one may be a rear camera. Additionally, the plurality of camera modules 180 may include at least one of a wide-angle camera, a telephoto camera, a color camera, a black-and-white camera, or an infrared (IR) camera (e.g., a time of flight (TOF) camera, a structured light camera). According to one embodiment of the disclosure, the IR camera may be operated as at least a part of a sensor module (e.g., the sensor module 176 in FIG. 1). For example, a TOF camera (e.g., a camera module 312 in FIG. 3B) may be operated as at least a part of a sensor module (e.g., the sensor module 176 in FIG. 1) for detecting the distance to a subject.

FIG. 3A is a front perspective view of an electronic device 300 according to an embodiment of the disclosure. FIG. 3B is a rear perspective view of an electronic device 300 according to an embodiment of the disclosure. FIG. 3C is an exploded perspective view of an electronic device 300 according to an embodiment of the disclosure.

Referring to FIGS. 3A and 3B, the electronic device 300 may include a housing 310 including a first surface (or front surface) 310A, a second surface (or back surface) 310B, and a side surface 310C surrounding a space between the first surface 310A and the second surface 310B.

In another embodiment (not illustrated) of the disclosure, the housing 310 may refer to a structure forming part of the first surface 310A, the second surface 310B, and the side surface 310C.

In an embodiment of the disclosure, the first surface 310A may be formed by a front plate 302 (e.g., a front plate 320 of FIG. 3C) of which at least a portion is substantially transparent. The front plate 302 may include a glass plate including various coating layers, or a polymer plate. In an embodiment of the disclosure, the second surface 310B may be formed by a substantially opaque back plate 311 (e.g., a back plate 380 in FIG. 3C). The back plate 311 may be formed, for example, by coated or colored glass, ceramic, polymer, metal (e.g., aluminum, stainless steel (STS), or magnesium), or a combination of at least two of the above materials. The side surface 310C may be coupled with the front plate 302 and the back plate 311, and may be formed by a side bezel structure 318 that includes metal and/or polymer.

In another embodiment of the disclosure, the back plate 311 and the side bezel structure 318 may be integrally formed, and may include the same material (e.g., a metal material, such as aluminum).

In the illustrated embodiment of the disclosure, the front plate 302 may include two first regions 310D that are bent from a partial region of the first surface 310A toward the back plate 311 and extend seamlessly. The first regions 310D may be positioned at both ends of a long edge of the front plate 302.

In the illustrated embodiment of the disclosure, the back plate 311 may include two second regions 310E that are bent from a partial region of the second surface 310B toward the front plate 302 and extend seamlessly. The second regions 310E may be included at both ends of a long edge of the back plate 311.

In another embodiment of the disclosure, the front plate 302 (or the back plate 311) may include only one of the first regions 310D (or the second regions 310E). In addition, in another embodiment of the disclosure, the front plate 302 (or the back plate 311) may not include some of the first regions 310D (or the second regions 310E).

In an embodiment of the disclosure, when viewed from the side of the electronic device 300, the side bezel structure 318 may have a first thickness (or width) in a lateral direction (e.g., a short side) in which the first regions 310D or the second regions 310E as described above are not included, and may have a second thickness thinner than the first thickness in a lateral direction (e.g., a long side) in which the first regions 310D or the second regions 310E are included.

In an embodiment of the disclosure, the electronic device 300 may include at least one of a display 301 (e.g., the display module 160 of FIG. 1), audio modules 303, 304, and 307 (e.g., the audio module 170 of FIG. 1), a sensor module (not illustrated) (e.g., the sensor module 176 of FIG. 1), camera modules 305 and 312 (e.g., the camera module 180 of FIG. 1 or a camera module 400 of FIG. 4), key input devices 317 (e.g., the input module 150 of FIG. 1), a light emitting element (not illustrated), and a connector hole 308 (e.g., the connection terminal 178 of FIG. 1). In another embodiment of the disclosure, the electronic device 300 may omit at least one of the components (e.g., the key input devices 317 or the light emitting element (not illustrated)) or may additionally include other components.

In an embodiment of the disclosure, the display 301 may be exposed through at least a portion of the front plate 302. For example, at least a portion of the display 301 may be exposed through the front plate 302 including the first surface 310A and the first regions 310D of the side surface 310C.

In an embodiment of the disclosure, a shape of the display 301 may be formed to be substantially the same as a shape of an outer edge of the front plate 302 adjacent to the display 301. In another embodiment (not illustrated) of the disclosure, in order to expand the area where the display 301 is exposed, an interval between the outer edge of the display 301 and the outer edge of the front plate 302 may be formed to be substantially the same as each other.

In an embodiment of the disclosure, the surface of the housing 310 (or the front plate 302) may include a display region in which the display 301 is visually exposed and content is displayed through pixels. For example, the display region may include the first surface 310A and the first region 310D of the side surface.

In another embodiment (not illustrated) of the disclosure, the display regions 310A and 310D may include a detection region (not illustrated) configured to obtain biometric information about a user. Here, it is to be understood that “the display regions 310A and 310D includes the detection region” means that at least a portion of the detection region may overlap the display regions 310A and 310D. For example, the detection region (not illustrated) may mean a region in which content may be displayed by the display 301 like other regions of the display regions 310A and 310D, and additionally, biometric information (e.g., fingerprint) about the user may be obtained.

In an embodiment of the disclosure, the display regions 310A and 310D of the display 301 may include a camera region 306. For example, the camera region 306 may be a region through which light reflected from a subject and received by the first camera module 305 passes. For example, the camera region 306 may include a region through which an optical axis (e.g., an optical axis OA of FIG. 4) of the first camera module 305 passes. Here, it is to be understood that “the display regions 310A and 310D includes the camera region 306” means that at least a portion of the camera region 306 may overlap the display regions 310A and 310D. For example, the camera region 306 may display content through the display 301 like other regions of the display regions 310A and 310D.

In various embodiment (not illustrated) of the disclosure, the screen display regions 310A and 310D of the display 301 may include a region through which a first camera module 305 (e.g., a punch hole camera) may be visually exposed. For example, in a region where the first camera module 305 is exposed, at least a portion of its edge may be surrounded by the screen display regions 310A and 310D. In an embodiment of the disclosure, the first camera module 305 may include a plurality of camera modules (e.g., the camera module 180 of FIG. 1 and the camera module 400 of FIG. 4).

In an embodiment of the disclosure, the display 301 may include at least one of audio modules 303, 304, and 307, a sensor module (not illustrated), a camera module (e.g., the first camera module 305), and a light emitting element (not illustrated) on a back surface of the screen display regions 310A and 310D. For example, the electronic device 300 may be disposed so that the camera module (e.g., the first camera module 305) faces the first surface 310A and/or the side surface 310C on the back surface (e.g., the surface facing a −Z-axis direction) of the first surface 310A (e.g., the front surface) and/or the side surface 310C (e.g., at least one surface of the first region 310D). For example, the first camera module 305 may not be visually exposed to the screen display regions 310A and 310D, and may include a hidden under display camera (UDC).

In another embodiment (not illustrated) of the disclosure, the display 301 may include or be disposed adjacent to a touch detection circuit, a pressure sensor capable of measuring the intensity (pressure) of the touch, and/or a digitizer detecting a magnetic field type stylus pen.

In an embodiment of the disclosure, the audio modules 303, 304, and 307 may include microphone holes 303 and 304 and a speaker holes 307.

In an embodiment of the disclosure, the microphone holes 303 and 304 may include a first microphone hole 303 formed in a partial region of the side surface 310C and a microphone hole 304 formed in a partial region of the second surface 310B. In the microphone holes 303 and 304, microphones for acquiring external sound may be disposed inside the housing 310. A plurality of microphones may be included to be able to detect a direction of sound. In an embodiment of the disclosure, the second microphone hole 304 formed in a partial region of the second surface 310B may be disposed adjacent to the camera modules 305 and 312. For example, the second microphone hole 304 may acquire sound when the camera modules 305 and 312 are executed or acquire sound when other functions are executed.

In an embodiment of the disclosure, the speaker hole 307 may include a receiver hole (not illustrated) for calls. The speaker hole 307 may be formed in a portion of the side surface 310C of the electronic device 300. In another embodiment of the disclosure, the speaker hole 307 and the microphone hole 303 may be implemented as one hole. Although not illustrated, the receiver hole (not illustrated) for calls may be formed in a different portion of the side surface 310C. For example, the receiver hole (not illustrated) for calls may be formed in a different portion of the side surface 310C (e.g., a portion facing the +Y-axis direction) opposite the portion of the side surface 310C in which the speaker hole 307 is formed (e.g., a portion facing a −Y-axis direction).

In an embodiment of the disclosure, the electronic device 300 may include a speaker that is fluidly connected to the speaker hole 307. In another embodiment of the disclosure, the speaker may include a piezo speaker in which the speaker hole 307 is omitted.

In an embodiment of the disclosure, a sensor module (not illustrated) (e.g., the sensor module 176 of FIG. 1) may generate an electrical signal or a data value corresponding to an internal operating state or an external environmental state of the electronic device 300. In an embodiment of the disclosure, the sensor module (not illustrated) may be disposed on at least some of the first surface 310A, the second surface 310B, or the side surface 310C (e.g., the first regions 310D and/or the second regions 310E) of the housing 310, and may be disposed on the back surface of the display 301 (e.g., a fingerprint sensor). For example, at least a portion of the sensor module (not illustrated) may be disposed beneath the display regions 310A and 310D so that it is not visually exposed, and form a detection region (not illustrated) on at least a portion of the display regions 310A and 310D. For example, the sensor module (not illustrated) may include an optical fingerprint sensor. In some embodiments (not illustrated) of the disclosure, the fingerprint sensor may be disposed on the second surface 310B as well as on the first surface 310A (e.g., the screen display regions 310A and 310D) of the housing 310. The sensor module may include, for example, at least one of a proximity sensor, a heart rate monitoring (HRM) sensor, a fingerprint sensor, a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or an illuminance sensor.

In an embodiment of the disclosure, the key input device 317 may be disposed on the side surface 310C of the housing 310 (e.g., the first regions 310D and/or the second regions 310E). In another embodiment of the disclosure, the electronic device 300 may not include some or all of the key input devices 317, and the key input device(s) 317 that is (are) not included may be implemented in other forms, such as a soft key, on the display 301. In another embodiment of the disclosure, the key input device may include a sensor module (not illustrated) forming the detection region (not illustrated) included in the display regions 310A and 310D.

In an embodiment of the disclosure, the connector hole 308 may accommodate a connector. The connector hole 308 may be disposed in the side surface 310C of the housing 310. For example, the connector hole 308 may be disposed in the side surface 310C to be adjacent to at least a portion of the audio module (e.g., the microphone hole 303 and the speaker hole 307). In another embodiment of the disclosure, the electronic device 300 may include a first connector hole 308 capable of accommodating a connector (e.g., a USB connector) for transmitting and receiving electric power and/or data to and from an external electronic device, and/or a second connector hole (not illustrated) capable of accommodating a connector (e.g., an earphone jack) for transmitting and receiving audio signals to and from an external electronic device.

In an embodiment of the disclosure, the electronic device 300 may include the light emitting element (not illustrated). For example, the light emitting element (not illustrated) may be disposed on the first surface 310A of the housing 310. The light emitting element (not illustrated) may provide state information about the electronic device 300 in the form of light. In another embodiment of the disclosure, the light emitting element (not illustrated) may provide a light source interworking with an operation of the first camera module 305. For example, the light emitting element (not illustrated) may include an LED, an IR LED, and/or a xenon lamp.

In an embodiment of the disclosure, the camera modules 305 and 312 (e.g., the camera module 180 of FIG. 1 and the camera module 400 of FIG. 4) may include the first camera module 305 (e.g., an under display camera) configured to receive light through the camera region 306 of the first surface 310A of the electronic device 300, the second camera module 312 configured to receive light through a partial region of the second surface 310B (e.g., a rear camera region 384 of FIG. 3C), and/or a flash 313.

In an embodiment of the disclosure, the first camera module 305 may include an under display camera (UDC) disposed on the back surface of the display 301. For example, the first camera module 305 may be positioned on some layers of the display 301, or positioned so that an optical axis of the lens (e.g., the optical axis OA of FIG. 4) passes through the display regions 310A and 310D of the display. In various embodiments of the disclosure, the first camera module 305 may be configured to receive light through the camera region 306 included in the display regions 310A and 310D. For example, the camera region 306 may be configured to display content similar to other regions of the display regions 310A and 310D when the first camera module 305 is not operating. For example, when the first camera module 305 is operating, the camera region 306 may not display content, and the first camera module 305 may receive light through the camera region 306.

In various embodiments (not illustrated) of the disclosure, the first camera module 305 (e.g., a punch hole camera) may be exposed through a portion of the display regions 310A and 310D of the display 301. For example, the first camera module 305 may be exposed as a partial region of the screen display regions 310A and 310D through an opening formed in a portion of the display 301.

In an embodiment of the disclosure, the second camera module 312 may include a plurality of camera modules (e.g., a dual camera, a triple camera, or a quad camera). However, the second camera module 312 is not necessarily limited to including a plurality of camera modules, and may include a single camera module.

In an embodiment of the disclosure, the first camera module 305 and/or the second camera module 312 may include one or a plurality of lenses, an image sensor (e.g., an image sensor 230 of FIG. 2), and/or an image signal processor (e.g., an image signal processor 260 of FIG. 2). The flash 313 may include, for example, a light emitting diode or a xenon lamp. In another embodiment of the disclosure, two or more lenses (infrared camera, wide-angle, and telephoto lenses) and image sensors may be disposed in the housing to face the direction in which one surface (e.g., the second surface 310B) of the electronic device 300 is facing.

Referring to FIG. 3C, the electronic device 300 may include the side bezel structure 318, a first support member 340 (e.g., a bracket), the front plate 320 (e.g., the front plate 302 in FIG. 3A), a display 330 (e.g., the display 301 in FIG. 3A), a printed circuit board 350 (e.g., a printed circuit board (PCB), a flexible PCB (FPCB), or a rigid-flexible PCB (RFPCB)), a battery 352, a second support member 360 (e.g., a rear case), an antenna 370, and a back plate 380 (e.g., the back plate 311 of FIG. 3B). In some embodiments of the disclosure, the electronic device 300 may omit at least one of the components (e.g., the first support member 340 or the second support member 360) or may additionally include other components. At least one of the components of the electronic device 300 may be the same as or similar to at least one of the components of the electronic device 300 of FIG. 3A or 3B, and the description thereof will not be repeated below.

In an embodiment of the disclosure, the first support member 340 may be disposed inside the electronic device 300 to be connected to the side bezel structure 318, or may be integrally formed with the side bezel structure 318. The first support member 340 may be formed of, for example, a metal material and/or a non-metal (e.g., polymer) material. The first support member 340 may have the display 330 coupled to or positioned on one surface and the printed circuit board 350 coupled to or positioned on the other surface.

In an embodiment of the disclosure, on the printed circuit board 350, a processor, memory, and/or interface may be disposed. The processor may include, for example, one or more of a central processing unit, an application processor, a graphic processing unit, an image signal processor, a sensor hub processor, or a communication processor.

In an embodiment of the disclosure, the memory may include, for example, volatile memory or non-volatile memory.

In an embodiment of the disclosure, the interface may include, for example, a high-definition multimedia interface (HDMI), a universal serial bus (USB) interface, a secure digital (SD) card interface, and/or an audio interface. The interface may electrically or physically connect the electronic device 300 to an external electronic device, for example, and may include a USB connector, an SD card/multimedia card (MMC) connector, or an audio connector.

In an embodiment of the disclosure, the battery 352 may be a device for supplying power to at least one of the components of the electronic device 300, and may include, for example, a primary cell which is not rechargeable, a secondary cell which is rechargeable, or a fuel cell. At least a portion of the battery 352 may be disposed, for example, on substantially the same plane as the printed circuit board 350. The battery 352 may be integrally disposed inside the electronic device 300, or may be disposed to be detachable from the electronic device 300.

In an embodiment of the disclosure, the antenna 370 may be disposed between the back plate 380 and the battery 352. The antenna 370 may include, for example, a near field communication (NFC) antenna, a wireless charging antenna, and/or a magnetic secure transmission (MST) antenna. The antenna 370 may, for example, perform short range communication with an external device, or may wirelessly transmit and receive electric power required for charging. In another embodiment of the disclosure, an antenna structure may be formed by the side bezel structure 318 and/or a portion of the first support member 340 or a combination thereof.

In an embodiment of the disclosure, the first camera module 305 may be coupled to the back surface of the display 330 to receive light through the camera region 306 of the front plate 320. For example, at least a portion of the first camera module 305 may be disposed on the first support member 340. For example, the image sensor of the first camera module 305 (e.g., the image sensor 230 of FIG. 2 or the image sensor 415 of FIG. 5) may receive light passing through the camera region 306 and a pixel array included in the display 330. For example, the camera region 306 may at least partially overlap the display region where content is displayed. For example, for the first camera module 305, the optical axis OA of the first camera module 305 may pass through a partial region of the display 330 and the camera region 306 of the front plate 320. For example, the partial region may include the pixel array including a plurality of light emitting elements. In an embodiment of the disclosure, a partial region of the display 330 facing the first camera module 305 may be formed as a transmission region having a transmittance that is specified as a portion of the display region where content is displayed. In an embodiment of the disclosure, the transmission region may be formed to have a transmittance ranging from about 5% to about 25%. In an embodiment of the disclosure, the transmission region may be formed to have a transmittance ranging from about 25% to about 50%. In an embodiment of the disclosure, the transmission region may be formed to have a transmittance of about 50% or more. Such a transmission region may include a region overlapping an effective region (e.g., a field of view (FOV)) of the first camera module 305, through which light formed by the image sensor (e.g., the image sensor 230 of FIG. 2 or the image sensor 415 of FIG. 5) for generating an image passes. For example, the transmission region of the display 330 may include a region having a lower pixel density and/or wiring density than a surrounding region.

In an embodiment of the disclosure, the second camera module 312 may be disposed so that the lens is exposed to the rear camera region 384 of the back plate 380 (e.g., the back surface 310B of FIG. 2) of the electronic device 300. The rear camera region 384 may be formed on at least a portion of the surface of the back plate 380 (e.g., the back surface 310B of FIG. 2). In an embodiment of the disclosure, the rear camera region 384 may be formed to be at least partially transparent so that the second camera module 312 receives external light through the rear camera region 384.

In an embodiment of the disclosure, at least a portion of the rear camera region 384 may protrude from the surface of the back plate 380 to a predetermined height. However, the rear camera region 384 is not necessarily limited thereto, and may be formed to be substantially the same plane as the surface of the back plate 380.

FIG. 4 is a perspective view of a camera module according to an embodiment of the disclosure.

Referring to FIG. 4, a camera module 400 according to an embodiment of the disclosure may include a camera housing 410 and a lens carrier 420 (e.g., the lens assembly 210 of FIG. 2) at least partially accommodated inside the camera housing 410. In an embodiment of the disclosure, the camera module 400 may be configured to receive external light through a partial region (e.g., the camera region 306 of FIG. 3C or the rear camera region 384) of a surface of an electronic device (e.g., the electronic device 300 of FIGS. 3A, 3B, and 3C).

In an embodiment of the disclosure, the camera housing 410 may include a base 411 and a cover 413. An opening 4131 through which at least a portion of a lens unit L and a lens barrel 425 is exposed may be formed in an upper surface of the cover 413. The opening 4131 may be at least partially aligned with an optical axis OA of the lens unit L. The cover 413 and the base 411 may form an inner space.

In various embodiments of the disclosure, on the base 411 of the camera housing 410, an image sensor (e.g., the image sensor 230 of FIG. 2 or an image sensor 415 of FIG. 5) and a circuit board (e.g., a board 412 of FIG. 5) electrically connected to the image sensor 230 may be disposed. In various embodiments of the disclosure, the image sensor 230 may be disposed to be at least partially aligned with the optical axis OA of the lens unit L. For example, the image sensor 230 may convert an optical signal received through the lens unit L into an electrical signal.

In an embodiment of the disclosure, at least a portion of the lens carrier 420 may be accommodated inside the camera housing 410. For example, a portion of the lens carrier 420 may protrude outside the camera housing 410 through the opening 4131.

In an embodiment of the disclosure, the lens carrier 420 may include the lens unit L including a plurality of lenses, and the lens barrel 425 surrounding the lens unit L. The lens unit L may be disposed so that at least a portion of the lens unit L is exposed through the opening 4131 of the camera housing 410.

In an embodiment of the disclosure, the camera module 400 may be electrically connected to the electronic device (e.g., the electronic device 300 of FIG. 3C) through a connection member 408. For example, the connection member 408 may include a connector 409 coupled to a printed circuit board (e.g., the printed circuit board 350 of FIG. 3C) of the electronic device 300. In an embodiment of the disclosure, the connection member 408 may include a circuit board (e.g., a circuit board 412 of FIG. 5) that includes a flexible region that is at least partially flexible.

In various embodiments of the disclosure, the connection member 408 may extend from an inner space of the camera housing 410 outside the camera housing 410 (e.g., the printed circuit board 350 of FIG. 3C). For example, the connection member 408 may include a flexible printed circuit board (FPCB).

FIG. 5 is an exploded perspective view of a camera module according to an embodiment of the disclosure.

Referring to FIG. 5, the camera module 400 may include the cover 413, the board 412, a spring 440, the lens carrier 420, a holder 430, wires 490, first coils 461, 462, 463, and 464, second coils 421 and 422, and magnets 451, 452, 453, and 454.

In an embodiment of the disclosure, the cover 413 and the board 412 may form the camera housing 410 in which an inner space is formed. For example, the board 412 may include the base 411 of FIG. 4. In the inner space, the lens carrier 420, the holder 430, the second coils 421 and 422 for an autofocus function, the first coils 461, 462, 463 and 464 for an image stabilization function, and the magnets 451, 452, 453, and 454 may be disposed. In an embodiment of the disclosure, the opening 4131 through which at least a portion of the lens unit L is exposed may be formed in the cover 413. In an embodiment of the disclosure, the first board 412 may have an image sensor 415 disposed thereon or may be electrically connected to the image sensor 415.

In an embodiment of the disclosure, the lens carrier 420 may include the lens unit L including one or more lenses, and the lens barrel 425 surrounding the lens unit L. For example, the lens unit L may include a plurality of lenses stacked in the direction of the optical axis OA. The lens unit L may be protected against external impact by being surrounded by the lens barrel 425.

In an embodiment of the disclosure, the lens carrier 420 may be coupled to the holder 430. For example, at least a portion of the lens carrier 420 may be inserted into an opening that at least partially passes through the holder 430. In an embodiment of the disclosure, the lens carrier 420 and the holder 430 may be connected by the spring 440. In an embodiment of the disclosure, the lens carrier 420 may be configured to move linearly in the direction of the optical axis relative to the holder 430 when the autofocus function is performed. For example, when the autofocus function is performed, the lens carrier 420 may move and the holder 430 may be fixed. In an embodiment of the disclosure, one or more second coils 421 and 422 may be disposed on a side surface of the lens carrier 420.

In an embodiment of the disclosure, the holder 430 may surround the lens carrier 420. The holder 430 may be configured to move linearly in a +X/−X-axis and +Y/−Y-axis directions together with the lens carrier 420. The holder 430 may be connected to the board 412 or a base (e.g., the base 411 in FIG. 4) through a wire 490. For example, wires 490 may be connected to four corner regions of the holder 430. Magnets 451, 452, 453, and 454 may be disposed in the holder 430. The magnets 451, 452, 453, and 454 may be disposed to at least partially face the second coils 421 and 422 in a +Z/−Z-axis direction.

In an embodiment of the disclosure, the magnets 451, 452, 453, and 454 may be disposed in the holder 430. For example, the magnets 451, 452, 453, and 454 may form inner surfaces of the holder 430, or may be disposed on the inner surfaces. For example, the magnets 451, 452, 453, and 454 may include a first magnet 451 disposed on a first inner surface 430a of the holder 430, a second magnet 452 disposed on a second inner surface 430b, a third magnet 453 disposed on a third inner surface 430c, and a fourth magnet 454 disposed on a fourth inner surface 430d.

In an embodiment of the disclosure, the first magnet 451 and the second magnet 452 may be related to the autofocus function of the camera module 400. In an embodiment of the disclosure, the first magnet 451, the second magnet 452, the third magnet 453, and the fourth magnet 454 may be related to the image stabilization function of the camera module 400.

In an embodiment of the disclosure, the first magnet 451 may be positioned in the +X-axis direction with respect to the lens carrier 420. The first magnet 451 may be positioned in the +Z-axis direction from a 1-1 coil 461. The first magnet 451 may at least partially overlap the 1-1 coil 461 when viewed in the +Z/−Z-axis direction. In an embodiment of the disclosure, the first magnet 451 may be spaced apart from a 2-1 coil 421 in the +X-axis direction. The first magnet 451 may at least partially overlap the 2-1 coil 421 when viewed in the +X/−X-axis direction.

In an embodiment of the disclosure, a first yoke member 481 may be disposed on an outer surface of the first magnet 451. For example, the first magnet 451 may be disposed between the first yoke member 481 and the 1-1 coil 461. The first yoke member 481 may be attached to the first magnet 451 to at least partially cover the outer surface of the first magnet 451. The first yoke member 481 may be configured to act as a shield against a magnetic field formed by the first magnet 451. For example, the first yoke member 481 may form a part of a path of the magnetic field.

In an embodiment of the disclosure, the second magnet 452 may be positioned in the −X-axis direction with respect to the lens carrier 420. The second magnet 452 may be positioned in the +Z-axis direction from the 1-2 coil 462. The second magnet 452 may at least partially overlap the 1-2 coil 462 when viewed in the +Z/−Z-axis direction. In an embodiment of the disclosure, the second magnet 452 may be spaced apart from a 2-2 coil 422 in the −X-axis direction. The second magnet 452 may at least partially overlap the 2-2 coil 422 when viewed in the +X/−X-axis direction.

In an embodiment of the disclosure, a second yoke member 482 may be disposed on an outer surface of the second magnet 452. For example, the second magnet 452 may be disposed between the second yoke member 482 and the 1-2 coil 462. The second yoke member 482 may be attached to the second magnet 452 to at least partially cover the outer surface of the second magnet 452. The second yoke member 482 may be configured to act as a shield against a magnetic field formed by the second magnet 452. For example, the second yoke member 482 may form a part of a path of the magnetic field.

In an embodiment of the disclosure, the third magnet 453 may be positioned in the +Y-axis direction with respect to the lens carrier 420. The third magnet 453 may be positioned in the +Z-axis direction from a 1-3 coil 463. The third magnet 453 may be spaced apart from the 1-3 coil 463 and at least partially overlap the 1-3 coil 463 when viewed in the +Z/−Z-axis direction.

In an embodiment of the disclosure, a third yoke member 483 may be disposed on an outer surface of the third magnet 453. For example, the third magnet 453 may be disposed between the third yoke member 483 and the lens carrier 420. The third yoke member 483 may be attached to the third magnet 453 to at least partially cover the outer surface of the third magnet 453. The third yoke member 483 may be configured to act as a shield against a magnetic field formed by the third magnet 453. For example, the third yoke member 483 may form a part of a path of the magnetic field.

In an embodiment of the disclosure, the fourth magnet 454 may be positioned in the −Y-axis direction with respect to the lens carrier 420. The fourth magnet 454 may be spaced apart from a 1-4 coil 464 in the +Z-axis direction. The fourth magnet 454 may at least partially overlap the 1-4 coil 464 when viewed in the +Z/−Z-axis direction.

In an embodiment of the disclosure, a fourth yoke member 484 may be disposed on an outer surface of the fourth magnet 454. For example, the fourth magnet 454 may be disposed between the fourth yoke member 484 and the lens carrier 420. The fourth yoke member 484 may be attached to the fourth magnet 454 to at least partially cover the outer surface of the fourth magnet 454. The fourth yoke member 484 may be configured to act as a shield against a magnetic field formed by the fourth magnet 454. For example, the fourth yoke member 484 may form a part of a path of the magnetic field.

In an embodiment of the disclosure, the first coils 461, 462, 463, and 464 may be disposed in a peripheral region of the board 412. For example, the image sensor 415 may be disposed in a central region of the board 412, and the 1-1 coil 461, the 1-2 coil 462, and the 1-3 coil 463, and the 1-4 coil 464 may be disposed in the peripheral region. In an embodiment of the disclosure, the first coils 461, 462, 463, and 464 may include a conductive pattern formed on the board, or may include a wound conductive wire disposed on the board. In an embodiment of the disclosure, the first coils 461, 462, 463, and 464 may include a conductive pattern or conductive wire surrounding an arbitrary axis parallel to the +Z/−Z-axis. In an embodiment of the disclosure, the first coils 461, 462, 463, and 464 may be arranged to face the lower surfaces of the magnets 451, 452, 453, and 454, respectively.

In an embodiment of the disclosure, the 1-1 coil 461 may be disposed in the +X-axis direction from the image sensor 415. For example, the 1-1 coil 461 may face the lower surface of the first magnet 451. In an embodiment of the disclosure, the 1-1 coil 461 may be configured to move the holder 430 and the lens carrier 420 in the +X/−X-axis direction through interaction with the first magnet 451. For example, when a current is applied to the 1-1 coil 461, a driving force may be applied to the first magnet 451 in the +X/−X-axis direction. The holder 430 in which the first magnet 451 is disposed and the lens carrier 420 coupled to the holder 430 may move in the +X/−X-axis direction.

In an embodiment of the disclosure, the 1-2 coil 462 may be disposed in the −X-axis direction from the image sensor 415. For example, the 1-2 coil 462 may face the lower surface of the second magnet 452. In an embodiment of the disclosure, the 1-2 coil 462 may be configured to move the holder 430 and the lens carrier 420 in the +X/−X-axis direction through interaction with the second magnet 452. For example, when a current is applied to the 1-2 coil 462, a driving force may be applied to the second magnet 452 in the +X/−X-axis direction. The holder 430 in which the second magnet 452 is disposed and the lens carrier 420 coupled to the holder 430 may move in the +X/−X-axis direction.

In an embodiment of the disclosure, the 1-3 coil 463 may be disposed in the +Y-axis direction from the image sensor 415. For example, the 1-3 coil 463 may face the lower surface of the second magnet 453. In an embodiment of the disclosure, the 1-3 coil 463 may be configured to move the holder 430 and the lens carrier 420 in the +Y/−Y-axis direction through interaction with the third magnet 453. For example, when a current is applied to the 1-3 coil 463, a driving force may be applied to the third magnet 453 in the +Y/−Y-axis direction. The holder 430 in which the third magnet 453 is disposed and the lens carrier 420 coupled to the holder 430 may move in the +Y/−Y-axis direction.

In an embodiment of the disclosure, the 1-4 coil 464 may be disposed in the −Y-axis direction from the image sensor 415. For example, the 1-4 coil 464 may face the lower surface of the fourth magnet 454. In an embodiment of the disclosure, the 1-4 coil 464 may be configured to move the holder 430 and the lens carrier 420 in the +Y/−Y-axis direction through interaction with the fourth magnet 454. For example, when a current is applied to the 1-4 coil 464, a driving force may be applied to the fourth magnet 454 in the +Y/−Y-axis direction. The holder 430 in which the fourth magnet 454 is disposed and the lens carrier 420 coupled to the holder 430 may move in the +Y/−Y-axis direction.

In an embodiment of the disclosure, the second coils 421 and 422 may be disposed on side surfaces of the lens carrier 420. The second coils 421 and 422 may be configured to electromagnetically interact with some of the magnets (e.g., the first magnet 451 and the second magnet 452) disposed in the holder 430.

Referring to FIG. 5, the second coils 421 and 422 may include the 2-1 coil 421 and the 2-2 coil 422. In an embodiment of the disclosure, the second coils 421 and 422 may be configured to move the lens carrier 420 in the direction of the optical axis (e.g., the +Z/−Z-axis direction). For example, when currents are applied to the second coils 421 and 422, the holder 430 may be fixed at a specified position in the +Z/−Z-axis direction, and the lens carrier 420 may move in the +Z/−Z-axis direction relative to the holder 430.

Referring to FIG. 5, the 2-1 coil 421 may at least partially overlap the first magnet 451 when viewed in the direction perpendicular to the optical axis OA (e.g., +X/−X-axis direction). For example, the 2-1 coil 421 may face the inner surface of the first magnet 451. An inner surface 450a of the first magnet 451 may include an N pole and an S pole. The N pole and the S pole may each at least partially overlap the 2-1 coil 421 when viewed in the +X/−X-axis direction.

In an embodiment of the disclosure, the 2-2 coil 422 may at least partially overlap the second magnet 452 when viewed in the direction perpendicular to the optical axis OA (e.g., the +X/−X-axis direction). For example, the 2-2 coil 422 may face the inner surface of the second magnet 452. The inner surface of the second magnet 452 may include an N pole and an S pole. The N pole and the S pole may each at least partially overlap the 2-2 coil 422 when viewed in the −X-axis direction.

In various embodiments (not illustrated) of the disclosure, the second coil may further include a 2-3 coil positioned in the −Y-axis direction from the third magnet 453 and a 2-4 coil positioned in the +Y-axis direction from the fourth magnet 454.

In an embodiment of the disclosure, the spring 440 may be disposed between the inner surface of the cover 413 and the lens carrier 420. For example, the spring 440 may be positioned in the +Z-axis direction from the lens carrier 420 and the holder 430. In an embodiment of the disclosure, the spring 440 may be configured to elastically connect the lens carrier 420 and the holder 430. For example, some region of the spring 440 may be connected to the holder 430 and other region may be connected to the lens carrier 420. The spring 440 may be configured to, when the lens carrier 420 moves relative to the holder 430, provide an elastic force so that the lens carrier 420 returns to its original state and guide a driving range of the lens carrier 420. In an embodiment of the disclosure, the spring 440 may include an open region so as not to block the lens of the lens carrier 420. In various embodiments (not illustrated) of the disclosure, the camera module 400 may further include a second spring positioned in the −Z-axis direction from the lens carrier 420 and the holder 430.

FIG. 6 is an exploded perspective view of a camera module according to an embodiment of the disclosure.

In giving description with reference to FIG. 6, contents overlapping with those described with reference to FIG. 5 will be omitted.

Referring to FIG. 6, a camera module 400 may change the distance between a lens and an image sensor 415 by moving a lens carrier 420 in a direction of an optical axis. In this way, a focus position of the camera module 400 may be adjusted in response to a position of a subject.

In an embodiment of the disclosure, the camera module 400 may include third coils 423 and 424 for an autofocus function. The third coils 423 and 424 may be provided to surround the lens carrier 420. For example, when viewed in a +Z/−Z-axis direction, the third coils 423 and 424 may be provided to surround an outer surface of the lens carrier 420 in their form. For example, the third coils 423 and 424 may include a conductive wire wound around an optical axis OA. For example, the third coils 423 and 424 may be configured to allow currents to flow clockwise or counterclockwise around the optical axis OA when viewed in the direction of the optical axis OA (e.g., +Z/−Z-axis direction).

Referring to FIG. 6, the third coils 423 and 424 may include a 3-1 coil 423 configured to allow a current to flow in a first rotation direction defined with respect to the optical axis, and a 3-2 coil 424 configured to allow a current to flow in a second rotation direction opposite to the first rotation direction. For example, the 3-1 coil 423 may be configured to allow a current to flow clockwise around the optical axis OA, and the 3-2 coil 424 may be configured to allow a current to flow counterclockwise around the optical axis OA.

In various embodiments of the disclosure, the 3-1 coil 423 and the 3-2 coil 424 may be disposed at positions spaced apart from each other in the direction of the optical axis OA. In various embodiments of the disclosure, the 3-1 coil 423 and the 3-2 coil 424 may be provided as one coil that is electrically connected but whose winding direction is opposite.

In various embodiments of the disclosure, the 3-1 coil 423 may electromagnetically interact with each of a first magnet 451, a second magnet 452, a third magnet 453, and a fourth magnet 454. For example, the 3-1 coil 423 may face any one of N poles or S poles of the magnets 451, 452, 453, and 454 in a direction perpendicular to the optical axis OA.

In various embodiments of the disclosure, the 3-2 coil 424 may electromagnetically interact with each of the first magnet 451, the second magnet 452, the third magnet 453, and the fourth magnet 454. For example, the 3-2 coil 424 may face the other one of N poles or S poles of the magnets 451, 452, 453, and 454 in a direction perpendicular to the optical axis OA.

In the embodiment of the disclosure, each of the magnets 451, 452, 453, and 454 may be configured so that the N pole and the S pole are formed at the same position. For example, each of the magnets 451, 452, 453, and 454 may be configured so that the N pole faces the 3-1 coil 423 and the S pole faces the 3-2 coil 424.

As described above, currents flow in different directions in the 3-1 coil 423 and the 3-2 coil 424 and the 3-1 coil 423 and the 3-2 coil 424 are arranged to face different polarities of the magnets 451, 452, 453, and 454, so that a driving force in the same direction (e.g., the direction of the optical axis OA) may be provided.

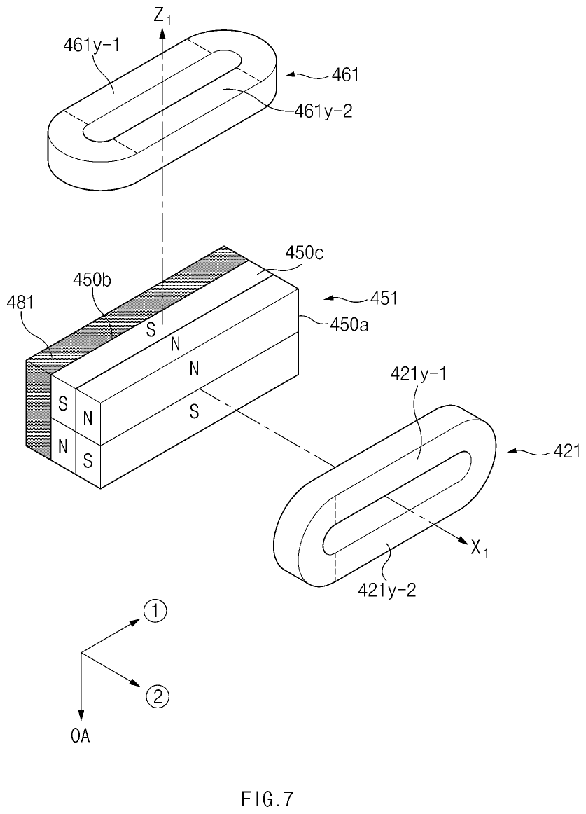

FIG. 7 is a diagram illustrating a magnet, a first coil, and a second coil of a camera module according to an embodiment of the disclosure.

Hereinafter, the description of the first magnet 451 may be equally applied to the second magnet 452, third magnet 453, and fourth magnet 454 illustrated in FIG. 5. The description of the 1-1 coil 461 may be equally applied to the 1-2 coil 462, the 1-3 coil 463, and the 1-4 coil 464 illustrated in FIG. 5. The description of the 2-1 coil 421 may be equally applied to the 2-2 coil 422 illustrated in FIG. 5.

Referring to FIG. 7, a first axis direction \textcircled{1}, which is a long side direction of the coil, and a second axis direction \textcircled{2} perpendicular to each of the first axis direction \textcircled{1} and the optical axis OA are defined.

In an embodiment of the disclosure, a camera module 400 may further include the first yoke member 481 for acting as a shield against the magnetic field of the first magnet 451. In an embodiment of the disclosure, the first yoke member 481 may be attached to an outer surface 450b of the first magnet 451. The outer surface 450b may include a surface opposite to the inner surface 450a of the first magnet 451. The outer surface 450b may include an N pole and an S pole. The first yoke member 481 may be attached to the first magnet 451 to at least partially cover each of the N pole and the S pole.

In various embodiments (not illustrated) of the disclosure, the camera module 400 may further include a second yoke member coupled to the second magnet 452, a third yoke member coupled to the third magnet 453, and a fourth yoke member coupled to the fourth magnet 454.

In an embodiment of the disclosure, the first magnet 451 may include a lower surface 450c facing the 1-1 coil 461, the inner surface 450a facing the 2-1 coil 421, and the outer surface 450b to which the first yoke member 481 is coupled. For example, the lower surface 450c may be a surface facing the −Z-axis direction. The lower surface 450c may include an N pole and an S pole. The N pole and the S pole may each at least partially face the 1-1 coil 461. For example, the inner surface 450a may have a larger area than the lower surface 450c. The inner surface 450a may include an N pole and an S pole. The N pole and the S pole may each at least partially face the 2-1 coil 421. For example, the outer surface 450b may have a larger area than the lower surface 450c. The outer surface 450b may include an N pole and an S pole. The N pole and the S pole may each be at least partially attached to the first yoke member 481.

In an embodiment of the disclosure, the 1-1 coil 461 may include a conductive wire or conductive pattern surrounding an arbitrary axis (Z1) parallel to the optical axis OA. The 1-1 coil 461 may include a first portion 461y-1 and a second portion 461y-2 extending long in the first axis direction \textcircled{1} perpendicular to the optical axis OA. Currents in opposite directions may flow through the first portion 461y-1 and the second portion 461y-2.

In an embodiment of the disclosure, the 1-1 coil 461 may be disposed so that, when viewed in the direction of the optical axis OA, the first portion 461y-1 faces the S pole of the lower surface 450c of the first magnet 451 and the second portion 461y-2 faces the N pole of the lower surface 450c of the first magnet 451. For example, portions of the 1-1 coil 461 to which currents in opposite directions are applied may be disposed to face different poles. Accordingly, a driving force in the same direction may be applied to the first portion 461y-1 of the 1-1 coil 461 and the second portion 461y-2 of the 1-1 coil 461. Referring to FIG. 5, in the 1-1 coil 461 and the 1-2 coil 462, the first axis direction \textcircled{1} may be a direction parallel to the +Y/−Y-axis. In the 1-1 coil 461 and the 1-2 coil 462, the second axis direction \textcircled{2} may be a direction parallel to the +X/−X-axis direction.

Referring to FIG. 5, in the 1-3 coil 463 and the 1-4 coil 464, the first axis direction \textcircled{1} may be a direction parallel to the +X/−X-axis. In the 1-3 coil 463 and the 1-4 coil 464, the second axis direction \textcircled{2} may be a direction parallel to the +Y/−Y-axis direction.

In an embodiment of the disclosure, the 2-1 coil 421 may include a conductive wire or conductive pattern surrounding an arbitrary second axis direction \textcircled{2}, which is parallel to the direction perpendicular to each of the optical axis OA and the first axis. The 2-1 coil 421 may include a third portion 421y-1 and a fourth portion 421y-2 extending long in the first axis direction \textcircled{1}. Currents in opposite directions may flow through the third portion 421y-1 and the fourth portion 421y-2. In an embodiment of the disclosure, the 2-1 coil 421 may be disposed so that, when viewed in the second axis direction \textcircled{2}, the third portion 421y-1 faces the N pole of the inner surface 450a of the first magnet 451 and the fourth portion 421y-2 faces the S pole of the inner surface 450a of the first magnet 451. For example, portions of the 2-1 coil 421 to which currents in opposite directions are applied may be disposed to face different poles. Accordingly, a driving force in the same direction may be applied to the third portion 421y-1 of the 2-1 coil 421 and the fourth portion of the 2-1 coil 421.

Referring to FIG. 5, in the 2-1 coil 421 and the 2-2 coil 422, the first axis direction \textcircled{1} may be a direction parallel to the +Y/−Y-axis and the second axis direction \textcircled{2} may be a direction parallel to the +X/−X-axis.

In an embodiment of the disclosure, when a current is applied to the 1-1 coil 461, a driving force may be applied to the first magnet 451 disposed in the holder 430 in the second axis direction \textcircled{2}. Accordingly, the holder 430 may move in the second axis direction \textcircled{2} with respect to the 1-1 coil 461 fixed to the base.

In an embodiment of the disclosure, when a current is applied to the 2-1 coil 421, a driving force may be applied to the 2-1 coil 421 disposed on the lens carrier 420 in the optical axis direction OA (e.g., the Z-axis/−Z-axis direction). Accordingly, the lens carrier 420 may move in the Z-axis/−Z-axis direction with respect to the first magnet 451 disposed in the holder 430.

In an embodiment of the disclosure, the first yoke member 481 may be coupled to the outer surface 450b of the first magnet 451 to act as a shield against the magnetic field generated by the first magnet 451. For example, the magnetic field generated by the first magnet 451 may form a closed loop including the N pole, the S pole, and the first yoke member 481.

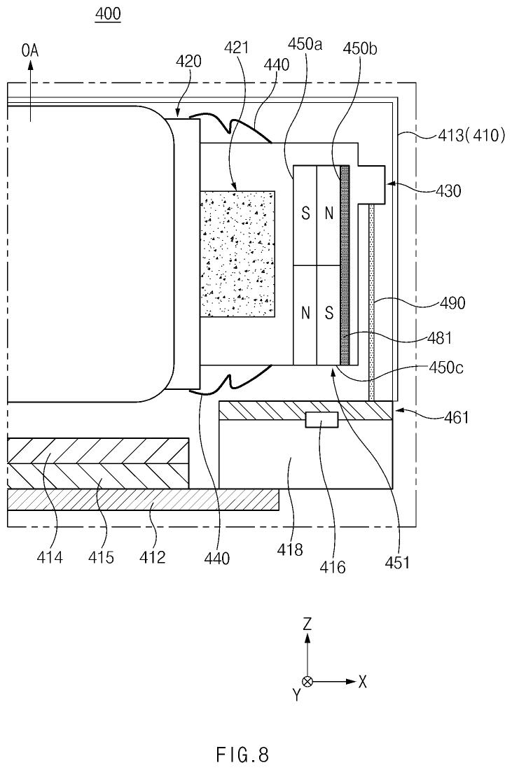

FIG. 8 is a cross-sectional view of a camera module according to an embodiment of the disclosure. FIG. 8 is a cross-sectional view including the optical axis and including the first magnet, the 1-1 coil, and the 2-1 coil.

Hereinafter, the description of the first magnet 451 may be equally applied to the second magnet 452, third magnet 453, and fourth magnet 454 illustrated in FIG. 5. The description of the 1-1 coil 461 may be equally applied to the 1-2 coil 462, the 1-3 coil 463, and the 1-4 coil 464 illustrated in FIG. 5. The description of the 2-1 coil 421 may be equally applied to the 2-2 coil 422 illustrated in FIG. 5.

Referring to FIG. 8, the camera module 400 may include the cover 413, the board 412, the support member 418, the lens carrier 420, the holder 430, the spring 440, the first magnet 451, the first yoke member 481, the 1-1 coil 461, and the 2-1 coil 421. In an embodiment of the disclosure, the cover 413 and the board 412 may be referred to as a camera housing (e.g., the camera housing 410 in FIG. 4). In an embodiment of the disclosure, the board 412 and the support member 418 may be referred to as a base (e.g., the base 411 in FIG. 4).

In an embodiment of the disclosure, the image sensor 415 and the optical filter 414 may be disposed on the board 412. The optical filter 414 may be disposed to cover the image sensor 415. The optical filter 414 and the image sensor 415 may be at least partially aligned with the optical axis OA.

In an embodiment of the disclosure, the support member 418 may be formed at an edge portion of the board 412. The 1-1 coil 461 may be disposed on the support member 418. For example, a second board 412 on which the 1-1 coil 461 is disposed may be disposed on the support member. The second board 412 may be formed integrally with the board 412, or may be electrically connected to the board 412.

Referring to FIG. 5, in various embodiments of the disclosure, the support member 418 may be disposed on a portion of an edge of the substrate 412 to at least partially surround the image sensor 415. For example, the support member 418 may be disposed in the +X/−X-axis direction and the +Y/−Y-axis direction with respect to the substrate 412.

In an embodiment of the disclosure, the holder 430 may be disposed inside the camera housing 410 and surround the lens carrier 420. The holder 430 may be connected to the board 412 and/or the support member 418 through the wire 490. The wire 490 may guide the movement of the holder 430 when the holder 430 moves in the +X/−X-axis or +Y/−Y-axis direction.

In an embodiment of the disclosure, the lens carrier 420 and the holder 430 may be connected through the spring 440. The spring 440 may guide the movement of the lens carrier 420 when the lens carrier 420 moves in the +Z/−Z-axis direction. Referring to FIG. 8, the spring 440 may be disposed on the holder 430 on each of the z/−z-axes.

In an embodiment of the disclosure, the camera module 400 may be configured to perform an autofocus function and an image stabilization function.

In an embodiment of the disclosure, the camera module 400 and/or the electronic device 101 may apply a current to the 2-1 coil 421, thereby moving the lens carrier 420 in the direction of the optical axis OA. In this case, the lens carrier 420 may move relative to the holder 430. In an embodiment of the disclosure, a portion of the spring 440 may be coupled to the holder 430 and another portion may be coupled to the lens carrier 420. The spring 440 may guide the relative movement of the lens carrier 420. In an embodiment of the disclosure, as the lens carrier 420 moves in the direction of the optical axis OA, the distance between the lens unit L included in the lens carrier 420 and the image sensor 415 in the direction of the optical axis OA direction may vary.

In an embodiment of the disclosure, the camera module 400 and/or the electronic device 101 may apply a current to the 1-1 coil 461, thereby moving the holder 430 in the direction perpendicular to the optical axis OA (e.g., the +X/−X and +Y/−Y directions). In this case, the lens carrier 420 may move together with the holder 430. The holder 430 may move relative to the camera housing 410 (e.g., the cover 413 and the board 412). In an embodiment of the disclosure, one side of the wire 490 may be coupled to the base, and the other side may be coupled to the holder 430. The wire 490 may guide the relative movement of the holder 430. In an embodiment of the disclosure, as the lens carrier 420 and the holder 430 move in the direction perpendicular to the optical axis OA, a position of an image formed on the image sensor 415 may change.

In an embodiment of the disclosure, the first magnet 451 may be fixedly disposed inside the holder 430. When the autofocus function is performed, the first magnet 451 may be fixed at a designated position. When the image stabilization function is performed, the first magnet 451 may move together with the holder 430 in the direction perpendicular to the optical axis OA.

In an embodiment of the disclosure, when viewed in the direction perpendicular to the optical axis OA, the inner surface of the first magnet 451 may at least partially overlap the 2-1 coil 421. For example, the inner surface of the first magnet 451 may include an N pole and an S pole, and each of the N pole and the S pole may face a portion through which currents in different directions flow (e.g., the third portion 421y-1 and the fourth portion 421y-2 in FIG. 7) of the 2-1 coil 421 in the direction perpendicular to the optical axis OA.

In an embodiment of the disclosure, when viewed in the direction of the optical axis OA, the lower surface 450c of the first magnet 451 may at least partially overlap the 1-1 coil 461. For example, the lower surface 450c of the first magnet 451 may include an N pole and an S pole, and each of the N pole and the S pole may face a portion through which currents in different directions flow (e.g., the first portion 461y-1 and the second portion 461y-2 in FIG. 7) of the 1-1 coil 461 in the direction parallel to the optical axis OA.

In an embodiment of the disclosure, the camera module 400 may include a Hall sensor 416 disposed on a portion adjacent to the 1-1 coil 461. The Hall sensor may detect the magnetic field of the first magnet 451. The electronic device 101 and/or the camera module 400 may detect positions of the lens carrier 420 and the holder 430 based on a signal detected from the Hall sensor 416.

In an embodiment of the disclosure, the first yoke member 481 may be coupled to the outer surface 450b of the first magnet 451. For example, the first magnet 451 may be disposed between the first yoke member 481 and the 2-1 coil 421. In an embodiment of the disclosure, the outer surface 450b of the first magnet 451 may include an N pole and an S pole. The first yoke member 481 may be attached to the outer surface 450b of the first magnet 451 to cover the N pole and the S pole.

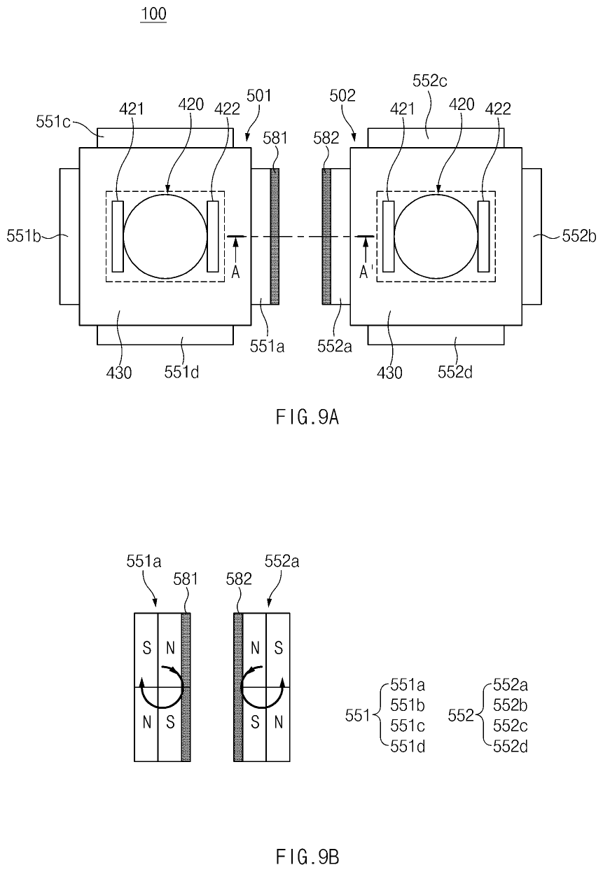

In an embodiment of the disclosure, the first yoke member 481 may form part of a path of the magnetic field formed by the first magnet 451. For example, the magnetic field generated by the first magnet 451 may form a closed loop path moving from the N pole to the S pole through the first yoke member 481. Thereby, the first yoke member 481 may reduce extension of the magnetic field outside the camera housing (e.g., the cover 413). Therefore, the influence of the magnetic field on components adjacent to the camera module 400 (e.g., a receiver or a second camera module 502 in FIG. 9A) may be reduced.

FIGS. 9A and 9B are diagrams illustrating an electronic device according to various embodiments of the disclosure. FIG. 9A is a plan view illustrating camera modules of the electronic device. FIG. 9B is a cross-sectional view taken along line A-A′ of FIG. 9A.

The electronic device 101 may include a first camera module 501 and a second camera module 502 adjacent to the first camera module 501. Each of the illustrated first camera module 501 and second camera module 502 may include the camera modules 400 described in FIGS. 4 to 8.

In an embodiment of the disclosure, each of the first camera module 501 and the second camera module 502 may be configured to perform an autofocus function of moving a lens carrier 420 in a direction of an optical axis and an image stabilization function of moving the lens carrier 420 and a holder 430 in a direction perpendicular to the optical axis.

In an embodiment of the disclosure, the first camera module 501 may include magnets 551 related to the autofocus function and the image stabilization function. In an embodiment of the disclosure, the second camera module 502 may include magnets 552 related to the autofocus function and the image stabilization function. Each of the first camera module 501 and the second camera module 502 may include at least two magnets.

Referring to FIGS. 9A and 9B, the first camera module 501 may include a first magnet 551a adjacent to the second camera module 502. A first yoke member 581 may be disposed on the first magnet 551a. The first yoke member 581 may act as a shield against a magnetic field formed by the first magnet 551a so that the magnetic field does not affect the second camera module 502. For example, referring to FIG. 9B, the magnetic field generated by the first magnet 551a may form a closed loop path including the N pole, the S pole, and the first yoke member 581.

Referring to FIGS. 9A and 9B, the second camera module 502 may include a second magnet 552a adjacent to the first camera module 501. A second yoke member 582 may be disposed on the second magnet 552a. The second yoke member 582 may act as a shield against a magnetic field formed by the second magnet 552a so that the magnet field does not affect the first camera module 501. For example, referring to FIG. 9B, the magnetic field generated by the second magnet 552a may form a closed loop path including the N pole, the S pole, and the second yoke member 582.

In various embodiments of the disclosure, yoke members may also be disposed on other magnets 551b, 551c, and 551d included in the first camera module 501. For example, when a component containing a magnetic material (e.g., the receiver or the camera module) is adjacent to the first camera module 501, the yoke member may be disposed on other magnets 551b, 551c, and 551d close to the component.

In various embodiments of the disclosure, the yoke member may also be disposed on other magnets 552b, 552c, and 552d included in the second camera module 502. For example, when a component containing a magnetic material (e.g., the receiver or the camera module) is adjacent to the second camera module 502, the yoke member may be disposed on other magnets 552b, 552c, and 552d close to the component.

A camera module 400 according to embodiments disclosed herein may include a camera housing 410 including a base 411 including a board 412 on which an image sensor 415 is disposed and a cover 413 coupled to the base, a lens carrier 420 at least partially disposed inside the camera housing 410 and configured to move in a direction of an optical axis, a holder 430 disposed inside the camera housing to be coupled to the lens carrier and configured to move in a direction perpendicular to the optical axis together with the lens carrier, a first coil 461, 462, 463, or 464 disposed on the base, a second coil 421 or 422 disposed on the lens carrier, a magnet 451, 452, 453, or 454 disposed in the holder and including a lower surface facing the first coil when viewed in a direction parallel to the optical axis and an inner surface facing the second coil when viewed in the direction perpendicular to the optical axis, and a yoke member 481, 482, 483, or 484 attached to an outer surface of the magnet, and each of the inner surface and the lower surface may include an N pole and an S pole.

In various embodiments of the disclosure, the outer surface of the magnet may include an N pole and an S pole, and the yoke member 481, 482, 483, or 484 may be attached to the outer surface to at least partially cover the N pole and the S pole.

In various embodiments of the disclosure, the N pole of the inner surface may be configured to be in surface contact with the S pole of the outer surface, and the S pole of the inner surface may be configured to be in surface contact with the N pole of the outer surface.

In various embodiments of the disclosure, the camera module may be configured to move the lens carrier in the direction parallel to the optical axis by applying an electrical signal to the second coil 421 or 422 and move the lens carrier and the holder in the direction perpendicular to the optical axis by applying an electrical signal to the first coil.

In various embodiments of the disclosure, the first coil 461, 462, 463, or 464 may include a conductive wire or conductive pattern surrounding an arbitrary axis parallel to the optical axis.

In various embodiments of the disclosure, the conductive pattern may be formed on the board.

In various embodiments of the disclosure, the conductive pattern may be formed in a peripheral region of the image sensor.

In various embodiments of the disclosure, the first coil 461, 462, 463, or 464 may include a first portion 461y-1 and a second portion 461y-2 that extend long in the direction of the optical axis and are configured to allow currents in opposite directions to flow, the first portion may at least partially face the N pole of the lower surface of the magnet when viewed in the direction of the optical axis, and the second portion may at least partially face the S pole of the lower surface of the magnet when viewed in the direction of the optical axis.

In various embodiments of the disclosure, the second coil 421 or 422 may include a conductive wire or conductive pattern surrounding an arbitrary axis perpendicular to the optical axis.

In various embodiment of the disclosure, the second coil 421 or 422 may include a third portion 421y-1 and a fourth portion 421y-2 that extend long in a first direction perpendicular to the optical axis and are configured to allow currents in opposite directions to flow, the third portion may at least partially face the N pole of the inner surface of the magnet when viewed in a second direction perpendicular to the first direction and the optical axis, and the fourth portion may at least partially face the S pole of the inner surface of the magnet when viewed in the second direction.

In various embodiments of the disclosure, the second coil 421 or 422 may be provided to surround the lens carrier when viewed in the direction of the optical axis, and the second coil 421 or 422 may include a 2-1 coil 421 configured to allow a current to flow in a direction rotating clockwise around the optical axis, and a 2-2 coil 422 configured to allow a current to flow in a direction rotating counterclockwise around the optical axis.

In various embodiments of the disclosure, the 2-1 coil 421 may at least partially face the N pole of the inner surface of the magnet when viewed in the direction perpendicular to the optical axis, and the 2-2 coil 422 may at least partially face the S pole of the inner surface of the magnet when viewed in the direction perpendicular to the optical axis.

In various embodiments of the disclosure, the camera module may further include a wire 490 extending from the base 411 to the holder 430.

In various embodiments of the disclosure, the camera module may further include a spring elastically connecting the lens carrier 420 and the holder 430.

A camera module 400 according to embodiments of the disclosure disclosed herein may include a camera housing 410 including a base 411 including a board 412 on which an image sensor 415 is disposed and a cover coupled to the base 411, a lens carrier 420 at least partially disposed inside the camera housing and configured to move in a direction of an optical axis, a holder 430 disposed inside the camera housing to be coupled to the lens carrier and configured to move in a first direction perpendicular to the optical axis and/or a second direction perpendicular to each of the optical axis and the first direction together with the lens carrier, a first magnet 451 disposed in the holder and positioned in the first direction from the lens carrier and a third magnet 453 positioned in the second direction, a first coil 461, 462, 463, or 464 disposed on the base and including at least one 1-1 coil 461 positioned in the first direction from the image sensor and at least one 1-3 coil 463 positioned in the second direction, a second coil 421 or 422 disposed on the lens carrier 420 and facing an inner surface of the first magnet 451 and/or the third magnet 453, and a yoke member 481, 482, 483, or 484 coupled to an outer surface of the first magnet 451 or the third magnet 453, and each of the outer surfaces and the inner surfaces of the first magnet 451 and the third magnet 453 may include an N pole and an S pole.

In various embodiments of the disclosure, the 1-1 coil 461 may at least partially overlap each of an N pole and an S pole of a lower surface of the first magnet 451 when viewed in the direction of the optical axis, and the 1-3 coil 463 may at least partially overlap each of an N pole and an S pole of a lower surface of the third magnet 453 when viewed in the direction of the optical axis.

In various embodiments of the disclosure, the yoke member 481, 482, 483, or 484 may include at least one of a first yoke member 481 at least partially attached to each of the N and S poles of the outer surface of the first magnet 451, or a third yoke member 483 at least partially attached to each of the N and S poles of the outer surface of the third magnet 453.

In various embodiments of the disclosure, the camera module may further include a second magnet 452 facing the first magnet 451 in the first direction, and the second coil 421 or 422 may include a 2-1 coil 421 facing the first magnet 451 in the first direction and a 2-2 coil 422 facing the second magnet 452 in the first direction.

In various embodiments of the disclosure, the second coil 421 or 422 may be provided in a form that surrounds the lens carrier when viewed in the direction of the optical axis, the second coil 421 or 422 may include the 2-1 coil 421 configured to allow a current to flow in a direction rotating clockwise around the optical axis, and the 2-2 coil 422 configured to allow a current to flow in a direction rotating counterclockwise around the optical axis, the 2-1 coil 421 may at least partially face the N pole of the inner surface of the first magnet 451 when viewed in the first direction and the N pole of the inner surface of the second magnet 452 when viewed in the second direction, and the 2-2 coil 422 may at least partially face the S pole of the inner surface of the first magnet when viewed in the first direction and the S pole of the inner surface of the second magnet when viewed in the second direction.

In various embodiments of the disclosure, the camera module may include a wire 490 extending from the base 411 to the holder 430 and a spring 440 elastically connecting the lens carrier 420 and the holder 430.

It should be understood that various embodiments of the disclosure and terms used in the embodiments do not intend to limit technical features disclosed in the disclosure to the particular embodiment disclosed herein; rather, the disclosure should be construed to cover various modifications, equivalents, or alternatives of embodiments of the disclosure. With regard to description of drawings, similar or related components may be assigned with similar reference numerals. In the disclosure disclosed herein, each of the expressions “A or B”, “at least one of A and B”, “at least one of A or B”, “A, B, or C”, “one or more of A, B, and C”, or “one or more of A, B, or C”, and the like used herein may include any and all combinations of one or more of the associated listed items. The expressions, such as “a first”, “a second”, “the first”, or “the second”, may be used merely for the purpose of distinguishing a component from the other components, but do not limit the corresponding components in other aspect (e.g., the importance or the order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

In this document, “adapted to or configured to” may be used interchangeably with, for example, “suitable for,” “having the ability to,” “changed to,” “capable of,” “made to,” or “designed to,” depending on the situation in terms of hardware or software. In some contexts, the expression “a device configured to” may mean that the device is “capable of” working with other devices or components. For example, the phrase “processor set (or configured) to perform A, B, and C” refers to a processor (e.g., an embedded processor) dedicated to performing those operations, or a general-purpose processor (e.g., CPU or AP) performing the corresponding operations by executing one or more programs stored in memory device (e.g., memory).

The term “module” used herein may represent, for example, a unit including one of hardware, software and firmware or a combination thereof. The term “module” may be interchangeably used with the terms “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific integrated circuit (ASIC) chip, a field-programmable gate array (FPGA), and a programmable-logic device for performing some operations, which are known or will be developed.

One or more non-transitory computer-readable recording medium may include a hard disk, a floppy disk, a magnetic medium (e.g., a magnetic tape), an optical medium (e.g., compact disc read only memory (CD-ROM), digital versatile disc (DVD)), a magneto-optical medium (e.g., a floptical disk), or a hardware device (e.g., read only memory (ROM), random access memory (RAM), flash memory, or the like). The program instructions may include machine language codes generated by compilers and high-level language codes that can be executed by computers using interpreters. The instructions in the claims can be stored in one memory or divided among multiple memories.

According to various embodiments of the disclosure, each component (e.g., the module or the program) of the above-described components may include one or plural entities. According to various embodiments of the disclosure, at least one or more components of the above components or operations may be omitted, or one or more components or operations may be added. Alternatively or additionally, some components (e.g., the module or the program) may be integrated in one component. In this case, the integrated component may perform the same or similar functions performed by each corresponding components prior to the integration. According to various embodiments of the disclosure, operations performed by a module, a programming, or other components may be executed sequentially, in parallel, repeatedly, or in a heuristic method, or at least some operations may be executed in different sequences, omitted, or other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A camera module comprising:
a camera housing including a base including a board on which an image sensor is disposed and a cover coupled to the base;
a lens carrier at least partially disposed inside the camera housing and configured to move in a direction of an optical axis;
a holder disposed inside the camera housing to be coupled to the lens carrier and configured to move in a direction perpendicular to the optical axis together with the lens carrier;
a first coil disposed on the base;
a second coil disposed on the lens carrier;
a magnet disposed in the holder and including a lower surface facing the first coil when viewed in a direction parallel to the optical axis and an inner surface facing the second coil when viewed in the direction perpendicular to the optical axis; and
a yoke member attached to an outer surface of the magnet facing opposite to the inner surface,
wherein each of the inner surface and the lower surface includes an N pole and an S pole.

2. The camera module of claim 1,
wherein the outer surface of the magnet includes an N pole and an S pole, and
wherein the yoke member is attached to the outer surface to at least partially cover the N pole and the S pole.

3. The camera module of claim 2,
wherein the N pole of the inner surface is configured to be in surface contact with the S pole of the outer surface, and
wherein the S pole of the inner surface is configured to be in surface contact with the N pole of the outer surface.

4. The camera module of claim 1, wherein the camera module is configured to:
move the lens carrier in the direction parallel to the optical axis by applying an electrical signal to the second coil, and
move the lens carrier and the holder in the direction perpendicular to the optical axis by applying an electrical signal to the first coil.

5. The camera module of claim 1, wherein the first coil includes a conductive wire or conductive pattern surrounding an arbitrary axis parallel to the optical axis.

6. The camera module of claim 5, wherein the conductive pattern is formed on the board.

7. The camera module of claim 6, wherein the conductive pattern is formed in a peripheral region of the image sensor.

8. The camera module of claim 1,
wherein the first coil includes a first portion and a second portion that extend long in the direction of the optical axis and are configured to allow currents in opposite directions to flow,
wherein the first portion at least partially faces the N pole of the lower surface of the magnet when viewed in the direction of the optical axis, and
wherein the second portion at least partially faces the S pole of the lower surface of the magnet when viewed in the direction of the optical axis.

9. The camera module of claim 1, wherein the second coil includes a conductive wire or conductive pattern surrounding an arbitrary axis perpendicular to the optical axis.

10. The camera module of claim 1,
wherein the second coil includes a third portion and a fourth portion that extend long in a first direction perpendicular to the optical axis and are configured to allow currents in opposite directions to flow,
wherein the third portion at least partially faces the N pole of the inner surface of the magnet when viewed in a second direction perpendicular to the first direction and the optical axis, and
wherein the fourth portion at least partially faces the S pole of the inner surface of the magnet when viewed in the second direction.

11. The camera module of claim 1,
wherein the second coil is provided to surround the lens carrier when viewed in the direction of the optical axis, and
wherein the second coil includes:
a 2-1 coil configured to allow a current to flow in a direction rotating clockwise around the optical axis, and
a 2-2 coil configured to allow a current to flow in a direction rotating counterclockwise around the optical axis.

12. The camera module of claim 11,
wherein the 2-1 coil at least partially faces the N pole of the inner surface of the magnet when viewed in the direction perpendicular to the optical axis, and
wherein the 2-2 coil at least partially faces the S pole of the inner surface of the magnet when viewed in the direction perpendicular to the optical axis.

13. The camera module of claim 1, further comprising:
a wire extending from the base to the holder.

14. The camera module of claim 1, further comprising:
a spring elastically connecting the lens carrier and the holder.

15. A camera module comprising:
a camera housing including a base including a board on which an image sensor is disposed and a cover coupled to the base;
a lens carrier at least partially disposed inside the camera housing and configured to move in a direction of an optical axis;
a holder disposed inside the camera housing to be coupled to the lens carrier and configured to move in a first direction perpendicular to the optical axis and/or a second direction perpendicular to each of the optical axis and the first direction together with the lens carrier;
a first magnet disposed in the holder and positioned in the first direction from the lens carrier, and a third magnet positioned in the second direction;
a first coil disposed on the base and including:
at least one 1-1 coil positioned in the first direction from the image sensor, and
at least one 1-3 coil positioned in the second direction;
a second coil disposed on the lens carrier and facing an inner surface of the first magnet and/or the third magnet; and
a yoke member coupled to an outer surface of the first magnet or the third magnet,
wherein each of the outer surfaces and the inner surfaces of the first magnet and the third magnet includes an N pole and an S pole.

16. An electronic device comprising:
a camera module including:
a camera housing including a base including a board on which an image sensor is disposed and a cover coupled to the base;
a lens carrier at least partially disposed inside the camera housing and configured to move in a direction of an optical axis;
a holder disposed inside the camera housing to be coupled to the lens carrier and configured to move in a direction perpendicular to the optical axis together with the lens carrier;
a first coil disposed on the base;
a second coil disposed on the lens carrier;
a magnet disposed in the holder and including a first surface facing the first coil when viewed in a direction parallel to the optical axis and a second surface facing the second coil and perpendicular to the first surface when viewed in the direction perpendicular to the optical axis; and
a yoke member attached to a third surface of the magnet facing opposite to the second surface,
wherein each of the first surface and the second surface includes an N pole and an S pole.

17. The electronic device of claim 16,
wherein the third surface of the magnet includes an N pole and an S pole, and
wherein the yoke member is attached to the third surface to at least partially cover the N pole and the S pole.

18. The electronic device of claim 16, wherein the camera module is configured to:
move the lens carrier in the direction parallel to the optical axis by applying an electrical signal to the second coil, and
move the lens carrier and the holder in the direction perpendicular to the optical axis by applying an electrical signal to the first coil.

19. The electronic device of claim 16, wherein the first coil includes a conductive wire or conductive pattern surrounding an arbitrary axis parallel to the optical axis.

20. The electronic device of claim 16,
wherein the first coil includes a first portion and a second portion that extend long in the direction of the optical axis and are configured to allow currents in opposite directions to flow,
wherein the first portion at least partially faces the N pole of the first surface of the magnet, and
wherein the second portion at least partially faces the S pole of the first surface of the magnet.
